(19) United States
(12) Patent Application Publication
(10) Pub. No.: US 2009/0136043 A1
(43) Pub. Date: May 28, 2009

(54) METHOD AND APPARATUS FOR PERFORMING KEY MANAGEMENT AND KEY DISTRIBUTION IN WIRELESS NETWORKS

(75) Inventors: Shreesha Ramanna, Vernon Hills, IL (US); Gino Anthony Scribano, Saint Charles, IL (US); Anda Mihaela Farcasanu, Glenview, IL (US)

Correspondence Address: Motorola, Inc.;Law Department, 1303 East Algonquin Road, 3rd Floor, Schaumburg, IL, 60196, US

(73) Assignee: MOTOROLA, INC., SCHAUMBURG, IL (US)

(21) Appl. No.: 11/944,766

(22) Filed: Nov. 26, 2007

(51) Int. Cl. H04L 9/08

(52) U.S. Cl. 380/281

(57) ABSTRACT

A method and apparatus are provided that enable a common key distribution and management system to be used for distributing and managing the keys that are used for authenticating, authorizing and ciphering exchanges between a wireless device and an ANP and that are used for authentication, authorizing and ciphering exchanges between wireless device and the SNP.

### TECHNICAL FIELD OF THE INVENTION

The invention relates to a wireless communications networks, and more particularly, to a method and apparatus for performing key distribution and key management in wireless communications networks.

### BACKGROUND OF THE INVENTION

Increases in data transmission rates and improvements in Quality of Service (QoS) in wireless communications networks have resulted in an increase in the types of services that are available over wireless networks. For example, in third-generation (3G) wireless networks currently operated by wireless network providers, various types of services are now available that enable wireless device users to access various types of content and applications over wireless networks, such as video files (e.g., movies), audio files (e.g., music), image files, text files, interactive games, etc. These types of services are generally referred to as multi-media services.

Next-generation wireless networks are currently being planned that will provide wireless device users with access to an even larger number of services. These next-generation networks, which are generally referred to as fourth-generation (4G) networks, promise even higher data transmission rates as well as improvements in QoS and traffic prioritization. It is expected that 4G networks will employ one or more transmission protocols such as, for example, Orthogonal Frequency Division Multiple Access (OFDMA), Mobile WiMAX, Ultra Mobile Broadband (UMB), Multiple-Input Multiple-Output (MIMO) to provide data transmission speeds up to or in excess of 100 megabits per second (Mbps). With such improvements, it is expected that these networks will provide wireless device users with seamless Internet access to all available Internet Protocol (IP)-based services.

With the increase in the types and number of services that are expected to become available to wireless device users, there will be a need for increased network security measures in order to prevent unauthorized persons from accessing resources and services that are intended for use only by authorized users. Access Network Providers (ANPs) currently apply security measures to ensure that only authorized wireless device users have over-the-air access to the networks. In addition, once a subscriber has over-the-air access to the network, security measures are also applied by Service Network Providers (SNPs) to ensure that only authorized wireless device users have access to services offered by the Service Network Providers (SNPs). The Access Network Providers (ANPs) and the Service Network Providers (SNPs) may or may not be the same entity.

Authentication and authorization techniques are typically used by Access Network Providers (ANPs) to control access to their networks. Likewise, authentication and authorization techniques are typically used by Service Network Providers (SNPs) to control access to the services they provide. In addition, the over-the-air exchanges between the wireless device users and the ANP are typically encrypted using ciphering techniques to prevent unauthorized persons from accessing the data contained in the exchanges in deciphered or decrypted format. Likewise, exchanges between the wireless device users and the SNP are typically ciphered or encrypted using ciphering techniques to prevent unauthorized persons from accessing the contained in the exchanges in deciphered format.

Key distribution and key management systems govern the performance of authentication, authorization and ciphering techniques in wireless networks. In 4G network architectures, key distribution and management will play an even larger role than in 3G networks due to the increased number and types of services that will be available to wireless device users over 4G networks. In these networks, a first key distribution and management system controls distribution and management of keys needed to allow the wireless device to gain over-the-air access to the wireless network via the ANP and to cipher and decipher messages exchanged between the wireless device and the ANP. In 4G networks, the ANP is typically implemented at the base station transmitter of the wireless network. These keys that are used for controlling over-the-air network access and ciphering of exchanges between a wireless device and an ANP are referred to herein as access keys.

In addition, proposed 4G network architectures utilize a second key distribution and management system that controls distribution and management of keys that enable the wireless device to access and use application services provided by an SNP and to cipher and decipher exchanges between the SNP and the wireless device. These keys that are used for accessing and using services provided by an SNP and ciphering and deciphering exchanges between the SNP and the wireless device are referred to herein as service keys.

FIG. 1 illustrates a message exchange diagram that demonstrates the manner in which these two independent key distribution and management systems will operate in proposed 4G networks. A wireless device 2 initially connects with the ANP 3 when the wireless device 2 is powered on during a connection establishment phase, which is represented in FIG. 1 by double-ended arrow 5. After the connection establishment phase, an authentication and authorization phase occurs, as indicated by double-ended arrow 7. This phase is performed using a protocol known as the Extensible Authentication Protocol (EAP). EAP supports multiple authentication methods and typically runs over data link layers, such as the Point-to-Point Protocol (PPP) layers and other link layers.

During the authentication/authorization phase, the ANP 3 requests that the wireless device 2 send the ANP 3 its true identity credentials, which are typically in the form of user@domain. When these credentials are sent by the wireless device 2 to the ANP 3, it then forwards the credentials to an Authentication Authorization Accounting (AAA) server 11, as indicated by arrow 9. These credentials are typically the Network Access Identifier (NAI) of the wireless device 2. The Authentication Authorization Accounting (AAA) server 11 uses the Network Access Identifier (NAI) to perform authentication and authorization of the wireless device 2. Assuming the wireless device 2 is authenticated and authorized, the Authentication Authorization Accounting (AAA) server 11 returns a master session key (MSK) to the ANP 3, which the ANP 3 stores in memory. The ANP 3 also derives its private key from the master session key (MSK) and stores it in memory.

After the authentication/authorization process has been performed, a session negotiation phase occurs during which the wireless device 2 and the ANP 3 exchange parameters that allow a session to be setup on each side of the over-the-air communication link. The session negotiation phase is represented in FIG. 1 by double-ended arrow 12.

After the session negotiation phase has occurred, a key exchange process is performed, which is represented by double-ended arrow 14. During this process, a public key/private key technology based on the well-known Diffie-Hellman algorithm is used to perform key exchange. As part of this process, the ANP 3 sends a public key to the wireless device 2. The wireless device 2 derives its private access key from the public key received from the ANP 3. The wireless device 2 will send it's public key to the ANP 3, which will derive it's private access key from the master session key (MSK) received from the Authentication Authorization Accounting (AAA) server 11 and the public key received from the wireless device 2. The private access keys that are now in the possession of the ANP 3 and the wireless device 2 are subsequently used during the session to authenticate and cipher over-the-air exchanges between the wireless device 2 and the ANP 3, as indicated by double-ended arrow 16. This process of access key distribution and management corresponds to the aforementioned first key distribution and management system.

If the wireless device user wishes to access services provided by an SNP, the wireless device 2 must participate in a second authentication/authorization process using one or more service keys. The wireless device 2 derives its service keys from a master session key (MSK) that has been pre-configured in the wireless device 2 by the wireless carrier. As described below, the ANP 3 obtains its service keys from an MSK received during subsequent EAP exchanges. This authentication/authorization process is governed by the aforementioned second key distribution and management system and is performed using the EAP protocol.

With reference again to FIG. 1, when the user of the wireless device 2 seeks access to services provided by an SNP 21, an Extensible Authentication Protocol (EAP) server 22 controlled by the SNP 21 interacts with the AAA server 11 to perform the authentication/authorization process associated with the SNP 21. This authentication/authorization process is represented in FIG. 1 by double-headed arrows 17 and 18. For ease of discussion and illustration, it will be assumed that the ANP 3 and the SNP 21 are the same entity. The wireless device 2 sends an Extensible Authentication Protocol (EAP) request to access the service provided by the SNP 21 to the Extensible Authentication Protocol (EAP) server 22. The Extensible Authentication Protocol (EAP) server 22 then sends an Extensible Authentication Protocol (EAP) request to the wireless device 2 for the identity of the wireless device 2. The requested identity information is the true identity in the form of user@domain.

The EAP server 22 receives the identity information from the wireless device 2 and uses this information to create an NAI, which is then sent via the ANP 3 to AAA server 11. If the ANP 3 and the SNP 21 are not provided by the same provider/carrier, the AAA server to which the NAI is sent will typically be different from the AAA server 11. For this example, it is assumed that the AAA server 11 receives the NAI and either performs the authentication/authorization process or forwards the NAI to another AAA server that performs the process.

The AAA server processes the NAI received from the EAP server 22 to perform the authentication and authorization processes. Assuming the wireless device 2 passes the authentication/authorization process, the AAA server 11 sends an MSK to the EAP server 22 in the open (i.e., unencrypted), which derives the service key from the MSK and stores it in memory. This ends the service key exchange process represented by double-ended arrows 17 and 18.

Subsequently, the wireless device 2 and the SNP 21 will use the service key during exchanges between themselves to authenticate and cipher/decipher the exchanges, as indicated by double-ended arrow 19. Because the exchanges between the SNP 21 and the wireless device 2 occur via the ANP 3, the access key will continue to be used to authenticate and cipher over-the-air exchanges between the wireless device 2 and the ANP 3.

It can be seen from the description of FIG. 1 that two respective key distribution and management systems are used to control access to resources of the ANP 3 and to control access to services provided by the SNP 21, respectively. The service keys of the second key distribution and management system generally have no relation to the public/private keys of the first key distribution and management system. Therefore, implementing these two separate key distribution and management systems results in additional resources, bandwidth and time being consumed to perform the tasks associated with each of the key distribution and management systems than that which would be consumed if a single key distribution and management system were used.

### SUMMARY OF THE INVENTION

The invention provides a method and a system for performing key distribution and key management in a wireless communications network. The apparatus comprises a first network component and a second network component. The first network component receives one or more key distribution requests associated with a wireless device and determines whether the one or more key distribution requests are to be granted. The second network component performs a key exchange process with the wireless device if the first network component determines that the one or more key distribution requests are to be granted. During the key exchange process, the second network component communicates with the wireless device via an over-the-air interface to cause information to be communicated to the wireless device to enable the wireless device to gain access to the wireless network and to one or more services associated with the one or more key distribution requests.

The method comprises: receiving one or more key distribution requests associated with a wireless device in a first network component, determining in the first network component whether the key distribution requests are to be granted, and performing a key exchange process with a wireless device in a second network component if the first network component determines that key distribution request or requests are to be granted. During the key exchange process, the second network component communicates with the wireless device via an over-the-air interface to cause information to be communicated to the wireless device to enable the wireless device to gain access to the wireless network and to one or more services associated with the one or more key distribution requests.

The invention also provides a computer program stored on a computer-readable medium in the form of instructions for receiving at least one master key sent from a first network component to a second network component, instructions for deriving an access key and one or more service keys from the at least one master key in the second network component, and instructions for performing a key exchange process to cause information to be communicated to a wireless to enable the wireless device to gain access to the wireless network and to one or more services associated with the one or more key distribution requests.

These and other features and advantages of the invention will become apparent from the following description, drawings and claims.

### BRIEF DESCRIPTION OF THE DRAWINGS

FIG. 1 illustrates a known message exchange diagram that demonstrates the manner in which two independent key distribution and management systems are expected to operate in a proposed 4G network.

FIG. 2 illustrates a message exchange diagram that demonstrates a common key distribution and management system of the invention in accordance with a first illustrative embodiment.

FIG. 3 illustrates a message exchange diagram that demonstrates a common key distribution and management system of the invention in accordance with a second illustrative embodiment.

FIG. 4 illustrates a flowchart that represents the method of the invention in accordance with an embodiment.

### DETAILED DESCRIPTION OF EXEMPLARY EMBODIMENTS

It would be desirable to provide a single key distribution and management system that is capable of distributing and managing the keys used to access and cipher exchanges between the wireless device and the ANP as well as to access and cipher exchanges between the wireless device and the SNP. Using a common key distribution and management system would reduce the number and amount of resources, bandwidth and time consumed in performing all of these tasks. In addition, having a common key distribution and management system would help operators standardize the procedures associated with key distribution and management within their networks and across different access technologies. Furthermore, use of a common key distribution and management system would facilitate the tasks of monitoring, analyzing and correlating network access and network-related security events.

In accordance with the invention, a method and apparatus are provided that enable a common key distribution and management system to be used for distributing and managing the keys that are used for authenticating, authorizing and ciphering exchanges between a wireless device and an ANP and that are used for authentication, authorizing and ciphering exchanges between a wireless device and an SNP. The manner in which the common key distribution and management system may be implemented will now be described with reference to a few illustrative embodiments. It should be noted that the illustrative embodiments described herein are intended to illustrate the principles and concepts of the invention and that the invention is not intended to be limited to these embodiments.

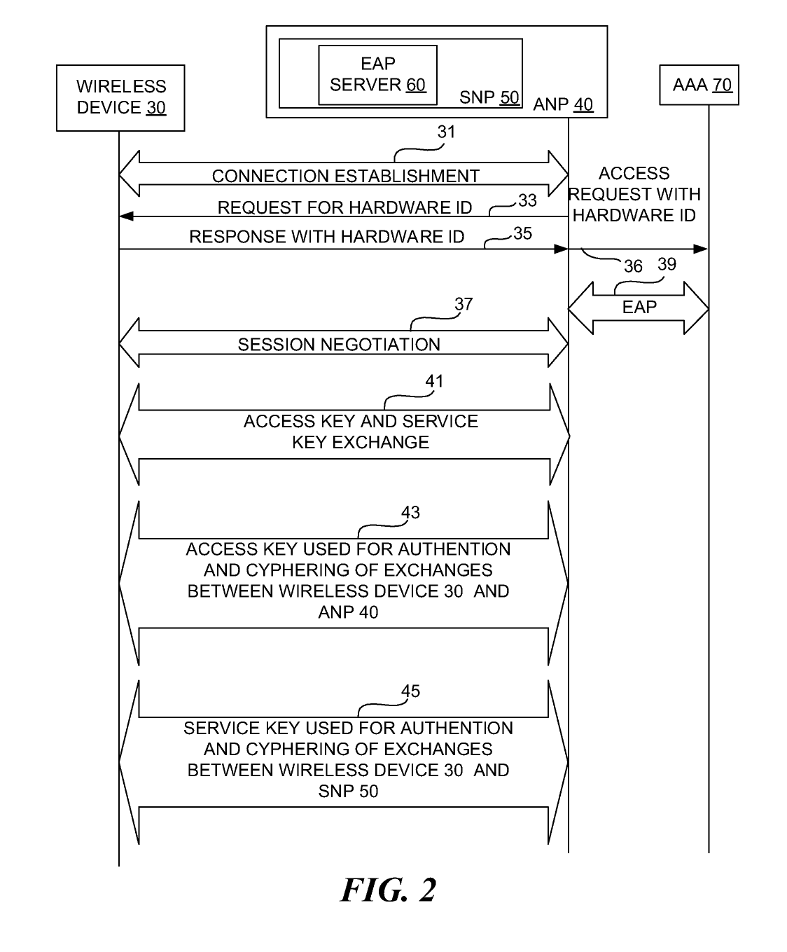

FIG. 2 illustrates a message exchange diagram that demonstrates the manner in which a common key distribution and management system of the invention may operate in accordance with a first illustrative embodiment. In accordance with this embodiment, it is assumed that an ANP 40 and an SNP 50 are both parts of a single entity. This entity includes an EAP server 60, which may be viewed as being part of the ANP 40 or part of the SNP 50.

During a connection establishment process, which is represented by double-headed arrow 31, an over-the-air connection is made between a wireless device 30 and the ANP 40. This typically will happen when the wireless device 30 is powered on. After the connection establishment phase, the ANP 40 sends a request to the wireless device 30 for the wireless device's hardware identity (ID), as indicated by arrow 33. This is typically the International Mobile Equipment Identity (IMEI), the mobile equipment identifier (MEID) or the electronic serial number (ESN) of the wireless device 30. The wireless device 30 sends its hardware ID to the ANP 40, as indicated by arrow 35. The EAP server 60 uses the hardware ID of the wireless device 30 to construct an NAI and sends the NAI to an AAA server 70 in an EAP request, as indicated by arrow 36. The AAA server 70 processes the NAI contained in the EAP request to perform authorization to determine whether the wireless device 30 is to have access to the network.

After or during performance of the authentication/authorization process by the AAA server 70, a session negotiation process is performed by the wireless device 30 and the ANP 40 to setup both sides of the over-the-air communications link between the wireless device 30 and the ANP 40. The session negotiation process is represented by double-ended arrow 37. In accordance with this embodiment, the service and access keys will be exchanged in one key exchange process. Commencing the authentication/authorization process earlier in the overall process ensures that the service and access keys will be made available to the wireless device 30 by the time that the session negotiation process has been completed.

In accordance with an embodiment, before or during the session negotiation process, an EAP process is performed by the EAP server 60 and the AAA server 70, as indicated by double-ended arrow 39. During the EAP process, the EAP server 60 sends a request for keys to the AAA server 70. Because the AAA server 70 has already determined that the wireless device 30 is authentic and authorized to access the network, the AAA server 70 need only determine whether the user of the wireless device 30 is authorized to use the requested service or services. This is necessary because a user of the wireless device 30 may be authorized to have network access through the ANP 40, but not authorized to access services provided by the SNP 50.

If the AAA server 70 determines that the user is authorized to access the requested services, the AAA server 70 sends an EAP response to the ANP 40 that includes an MSK from which the access key will be derived as well as an MSK from which the service key or keys will be derived. Alternatively, the access and service keys may be derived from the same MSK. The double-ended arrow 39 represents the EAP request sent from the SNP 50 via the ANP 40 to the AAA server 70 and the EAP response sent from the AAA server 70 to the SNP 50 via the ANP 40.

The access and service MSKs may be sent from the AAA server 70 to the ANP 40 in separate EAP responses or they may be bundled together in a single EAP response. In addition, instead of the AAA server 70 sending MSKs to the ANP 40, the AAA server may send the actual access and service keys in encrypted form to the ANP 40.

Assuming the AAA server 70 sends the ANP 40 an MSK as opposed to actual access and service keys, the AAA server 70 will typically use normal Diameter/Radius procedures to push the MSK down to the ANP 40. After the ANP 40 has received the MSK, a single key exchange process will be performed by the ANP 40 to exchange the public access key or keys with the wireless device 30. The wireless device 30 then derives the private access key by using both the pre-configured MSK stored in the wireless device 30 and the public key received from the ANP 40. As part of this key exchange process, the service keys are also derived by the ANP 40 from the MSK, and are sent to the wireless device 30 in encrypted form using the private access key to encrypt them. The key exchange process is represented by the double-ended arrow 41 and will typically be performed using the aforementioned Diffie-Hellman algorithm, or some variation thereof. Therefore, the ANP 40, or more specifically, the SNP 50, will use the MSK to derive the private access and service keys and will use them for access and service ciphering and authentication.

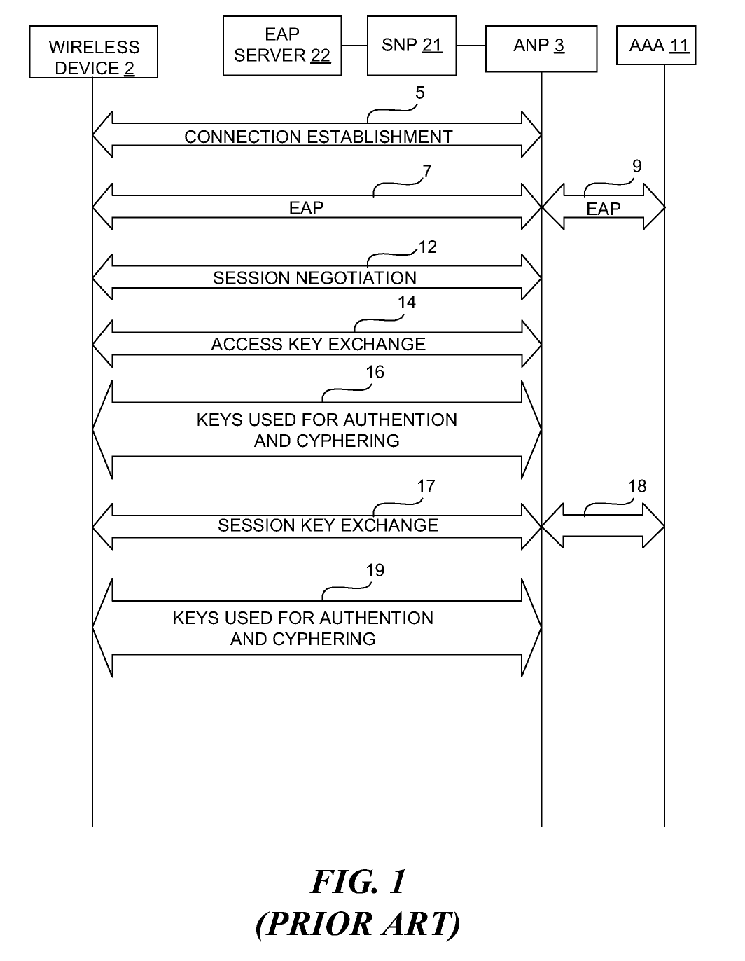

From a comparison of FIGS. 1 and 2, it can be seen that the key exchange process represented in FIG. 1 by double-ended arrow 14 is not included in FIG. 2. By eliminating this first over-the-air key exchange process and using the single common key exchange process represented in FIG. 2 by double-ended arrow 41, the number of resources and the amount of bandwidth that are utilized during the overall process represented by FIG. 2 are reduced. For example, using the common key exchange process represented in FIG. 2 by double-ended arrow 41, the number of over-the-air messages exchanged per call will typically be reduced by about six messages compared to the number of over-the-air messages exchanged per call using the two separate and independent key exchange processes represented in FIG. 1 by double-ended arrows 14 and 17. When the large volume of calls that are occurring over the network is taken into account, it can be seen that the invention provides an enormous reduction in the overall number of messages that are exchanged over the network, and thus an enormous reduction in the amount of bandwidth consumed and in the number of network resources used.

In addition, the more efficient use of network resources and bandwidth provided by the invention result in other benefits, such as an increase in the number of callers that can be handled by each network base station, for example, which results in more efficient use of network base stations and therefore a reduced demand for new base stations and associated equipment and infrastructure. Furthermore, reducing the number of messages that are required per call also reduces the number of failed messages, and thus the number of messages that have to be resent. This further reduces the amount of bandwidth consumed and the number of network resources used for calls. In addition, the key exchange process may now be more easily standardized because fewer issues need to be taken into account due to fewer exchanges needing to be made and due to the reduced complexity of the overall process.

After the access and service keys have been derived, the wireless device 30 and the ANP 40 and SNP 50 are able to authenticate and cipher/decipher exchanges between them in the typical manner, as indicated by double-ended arrows 43 and 45. It should be noted that although this embodiment has been described as using an EAP procedure, the key exchange process during which the public access key is exchanged along with the encrypted service key may be performed without an EAP procedure.

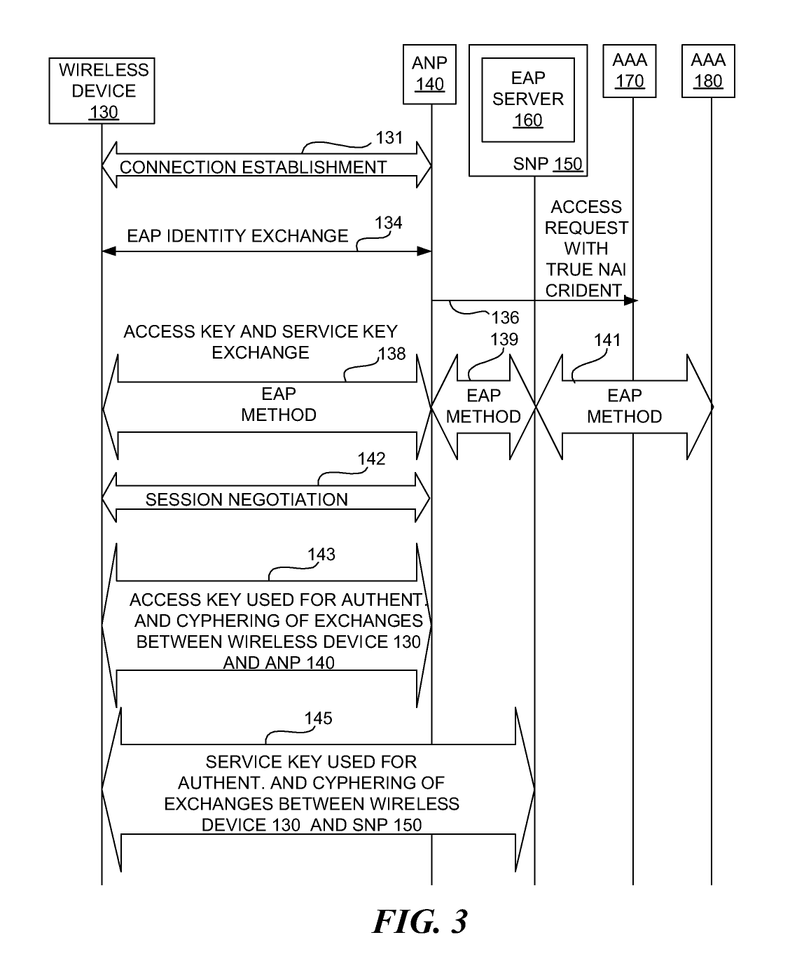

FIG. 3 illustrates a message exchange diagram that demonstrates the manner in which a common key distribution and management system of the invention may operate in accordance with a second illustrative embodiment. In accordance with this embodiment, an ANP 140 is not providing any services, but is functioning as a pass-through conduit to an SNP 150. Because the ANP 140 is functioning as a conduit as opposed to a service provider, the normal EAP procedures that are implemented by an SNP 150 through an EAP server 160 of the SNP 150 may be used for authentication and for distribution of the access and service keys, as will now be described in detail.

During a connection establishment process, which is represented by double-headed arrow 131, an over-the-air connection is made between a wireless device 130 and the ANP 140. This typically occurs when the wireless device 130 is powered on. After the connection establishment process has been completed, an EAP identity exchange phase is started, as indicated by arrow 134. As part of this process, the ANP 140 requests and obtains the user identity associated with the wireless device 130, which, as stated above, is not the same as the hardware ID of the wireless device 130. The ANP 140 constructs an NAI based on the user identity and forwards the NAI to an AAA 170 associated with the ANP 140 as part of an access request, as indicated by arrow 136. The form of the NAI used for this purpose is defined in, for example, Request For Comment (RFC) 4282, which defines the NAI as a user name followed by the “@” symbol followed by the user's realm (e.g., the user's home ANP). Thus, the NAI typically contains information structured in the form of “user@domain” or “user@realm”.

NAIs are used for, among other purposes, routing AAA transactions to the user's home realm. Usually, the home realm appears in the realm portion of the NAI, but in some cases a different realm may be used. In roaming, the purpose of the NAI is to identify the user as well as to assist in the routing of an authentication request to the proper AAA server. The NAI is not necessarily the same as the user's e-mail address or the user identity submitted in an application layer authentication. In the example represented by FIG. 3, it is assumed that the wireless device 130 is not roaming, and that the AAA server 170 is the AAA server of the user's home realm. It will be understood, however, that the wireless device 130 could be roaming, in which case the AAA server 170 would use the NAI to ascertain an AAA server associated with the user's home realm. In the latter case, the AAA server associated with the user's home realm would perform the access authentication and authorization to determine whether the wireless device 130 is to be given access to the resources of the network that is accessible through ANP 140.

Assuming the AAA server 170 receives the access request and the NAI and determines that the wireless device 130 is authorized to access the network, the wireless device 130 will not be rejected, and so will continue to have access to the network via the ANP 140. After the authentication/authorization process has been performed, if the user of the wireless device 130 wishes to access one or more services provided by an SNP 150, the wireless device 130 invokes an EAP method. The double-ended arrows 138, 139 and 141 in FIG. 3 represent the EAP method or methods that perform authentication/authorization/accounting as well as key distribution. RFC 3748 defines EAP and a variety of EAP methods that function as mechanisms for performing authentication and key exchange. Other RFCs exist that also define EAP or various attributes of EAP, and the invention is not limited to any particular version of EAP defined by any particular RFC.

The EAP method represented by double-ended arrows 138, 139 and 141 is performed as follows. The wireless device 130 requests access to one or more services provided by SNP 150. The request includes the NAI constructed using the user's identity, e.g., user@realm. The EAP server 160 of the SNP 150 then sends an EAP request for authentication/authorization and key distribution to an AAA server 180 associated with the SNP 150.

Assuming the AAA server 180 is able to authenticate the user and authorize the user for the requested service or services, the AAA server 180 distributes a pair-wise master key (PMK) to the EAP server 160. The EAP server 160 derives the public access key and the service key from the PMK and distributes the public access key to the ANP 140 and to the wireless device 130. The EAP server 160 also distributes the PMK to the ANP 140, which derives the service key from the PMK. The EAP server 160 may include the public access keys in the EAP transactions with the wireless device 130 and the ANP 140 as part of EAP success messages. The ANP 140 will use the public access key to derive its private access key. Likewise, the wireless device 130 will use the public access key to derive its private access key. In networks that use EAP to allow wireless devices to access services using the ANP as a pass-through conduit, the wireless devices have logic that are pre-configured with service keys. Therefore, in accordance with this embodiment, no service key is distributed to the wireless device 130. Rather, the wireless device 130 will obtain the service key from its pre-configured logic and from a digital signature derived by the ANP 140 from the PMK and sent by the ANP 140 to the wireless device 130.

Once the wireless device 130 has obtained the private access key and the service key, a session negotiation process is performed by the wireless device 130 and the ANP 140 to setup both sides of the over-the-air communications link between the wireless device 130 and the ANP 140. The session negotiation process is represented in FIG. 3 by double-ended arrow 142. After the session negotiation process has been performed, the private access key is used in over-the-air exchanges between the wireless device 130 and the ANP 140 for authentication and ciphering/deciphering, as indicated by double-ended arrow 143. Likewise, the service key or keys are used for authentication and ciphering of exchanges between the wireless device 130 and the SNP 150, as indicated by double-ended arrow 145.

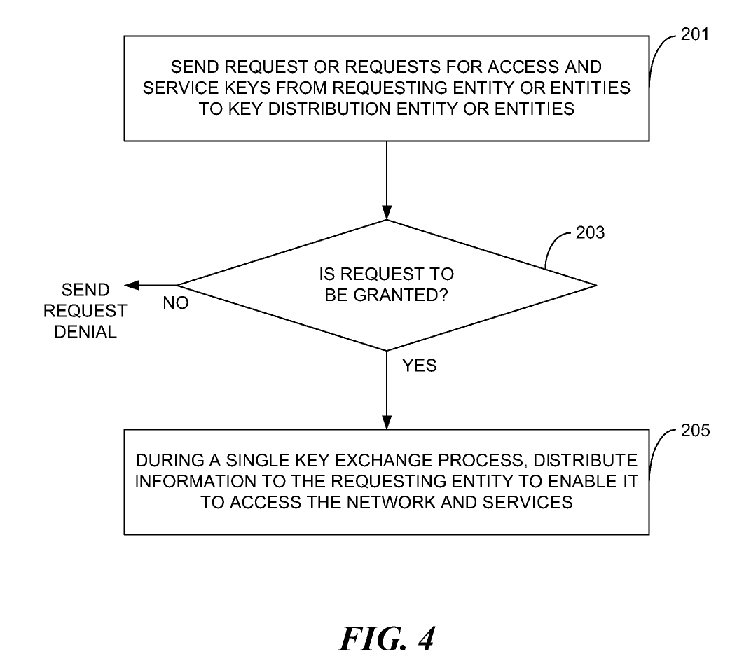

FIG. 4 illustrates a flowchart that represents the method of the invention in accordance with an embodiment. As described above with reference to the embodiments represented by FIGS. 2 and 3, the manner in which a common key distribution and management system may be used for distribution and management of the access and service keys will vary depending on the configurations of the corresponding networks and the protocols that are implemented in those networks. The method represented by the flowchart illustrated in FIG. 4 is intended to apply to both of the embodiments represented by FIGS. 2 and 3, and therefore illustrates only method steps that are common to both embodiments.

With reference to FIG. 4, one or more key distribution requests for at least one access key and at least one service key are forwarded from a requesting entity to a key distribution entity, as indicated by block 201. The requesting entity may be, for example, a wireless device, an ANP, an SNP, an EAP server, etc., or a combination of two or more such entities working in concert to generate and send the request. The access and service keys may be requested in a single exchange that includes a request for all keys or in multiple respective exchanges that include respective requests for respective keys. The access and service keys may be requested in different exchange processes, but preferably are requested during a single exchange process. The invention is not limited to this functionality being implemented in any particular manner.

One or more key distribution entities receive the key distribution request or requests and perform certain tasks associated with the request or requests to determine whether or not distribution of the access and service keys should be performed, as indicated by block 203. The tasks represented by block 203 may be performed, for example, by two AAA servers: one that performs authentication, authorization and accounting and determines whether or not to grant the request and distribute an access key to the requesting entity, and another that performs authentication, authorization and accounting and determines whether or not to grant the request and distribute one or more service keys to the requesting entity.

Alternatively, the tasks represented by block 203 may be performed by a single entity, such as, for example, a single AAA server that performs authentication, authorization and accounting for both network access and use of services and determines whether or not to grant the request and distribute the access key and one or more service keys to the requesting entity. Alternatively, the key distribution entity or entities may be, for example, a combination of one or more AAA servers, one or more SNP servers and one or more ANP servers that cooperate to perform network access and service authentication and authorization to determine whether the request is to be granted.

If the key distribution entity or entities determine that the request is to be granted, all of the information needed by the wireless device to enable it to access the network and the services is distributed to the wireless device during a single key exchange process, as indicated by block 205. With respect to the embodiment represented by FIG. 2, the access and service keys, or their corresponding MSK or PMK, are distributed to the requesting entity during a single key exchange process. The term “master key”, as that term is used herein, is intended to denote both an MSK and a PMK. Thus, with respect to the embodiment represented by FIG. 2, block 205 may represent distribution of access and service keys or distribution of the associated master keys from which the access and service keys are derived. With respect to the embodiment represented by FIG. 3, the wireless device is pre-configured with the service keys, so it is unnecessary for the service keys to be distributed to the wireless device. In that case, the process represented by block 205 comprises distributing the access keys during the EAP process, but not distribution of service keys since the wireless device obtains the service key from its own pre-configuration.

For ease of describing the principles and concepts of the invention, any reference herein to the distribution of access and service keys to the wireless device is intended to include one or more of the following: (1) distribution to the wireless device of one or more access keys and one or more service keys, and (2) distribution to the wireless device of one or more master keys from which one or more access and service keys can be derived by the wireless device. In other words, any reference herein to the distribution of access and service keys to the wireless device is intended to mean that some type of information, regardless of the form in which the information is embodied, is distributed to the wireless device that enables the wireless device to gain access to the network and to one or more services.

The key exchange process may be made up of a single exchange or may be made up of a set of multiple exchanges. However, the over-the-air exchange between the network and the wireless device that results in the public access and service keys being sent together from the network to the wireless device is a single exchange process. The key exchange process is typically made up of multiple exchanges because some handshaking will typically be involved on each side of the air interface. For example, one side may send an exchange to other that (1) identifies the information that is about to be sent, (2) notifies the other side that it is ready to receive the information, and (3) notifies the other side that the information was successfully received or was not successfully received and will have to be resent. Information may need to be sent multiple times before it is successfully received.

The network components described above, such as the ANP, the SNP, the AAA servers, the EAP servers, etc., typically each include some type of processor that performs algorithms in hardware, software or in a combination of hardware, software and/or firmware. These processors may be any type of computational devices that are suitable for performing the functions described above with reference to FIGS. 2-4, including, for example, a microprocessor, a microcontroller, an application specific integrated circuit (ASIC), a programmable gate array, etc. The processors may be implemented solely in hardware or in a combination of hardware and software or firmware. In the case where the processor is implemented in a combination of hardware and software, the software programs executed by the processor will be stored in some other computer-readable medium.

The computer-readable medium may be well known memory devices such as, for example, random access memory (RAM), dynamic RAM (DRAM), flash memory, read only memory (ROM) compact disk ROM (CD-ROM), digital video disks (DVDs), magnetic disks, magnetic tapes, etc. The invention also encompasses electrical signals modulated on wired and wireless carriers (e.g., electrical conductors, wireless carrier waves, etc.) in packets and in non-packet formats.

The invention has been described with reference to certain embodiments for the purpose of demonstrating the principles and concepts of the invention. It should be noted, however, that the invention is not limited to the embodiments described herein. For example, while the invention has been described with reference to 4G networks and certain protocols, such as EAP, the invention is not limited to any particular network technology or protocols. As will be understood by those skilled in the art, many modifications can be made to the embodiments described herein, and all such modifications are within the scope of the invention.

What is claimed is:

1. A system for performing key distribution and key management in a wireless communications network, the system comprising:
a first network component, the first network component receiving one or more key distribution requests associated with a wireless device, the first network component determining whether said one or more key distribution requests are to be granted; and
a second network component, the second network component performing a key exchange process with a wireless device if the first network component determines that said one or more key distribution requests are to be granted, the second network component communicating with the wireless device during the key exchange process via an over-the-air interface to cause information to be communicated to the wireless device that enables the wireless device to gain access to the wireless network and to one or more services associated with said one or more key distribution requests.

2. The system of claim 1, wherein the second network component receives at least one master key from the first network component if the first network component determines that said one or more key distribution requests are to be granted, the second network component deriving at least one public access key and at least one service key from said at least one master key, the second network component deriving at least one private access key from said at least one public access key and using said at least one private access key to encrypt said at least one service key to obtain at least encrypted service key, the information communicated to the wireless device via the over-the-air interface including said at least one public access key and said at least one encrypted service key.

3. The system of claim 2, wherein the first network component is an authentication-authorization-accounting (AAA) server and the second network component is an access network provider (ANP), the AAA server receiving said one or more key distribution requests directly or indirectly from the ANP, the AAA server performing at least an authentication and authorization process to determine whether or not the wireless device is to be granted access to the wireless network and to determine whether or not the wireless device is to be granted use of one or more services, the ANP granting or denying to the wireless device access to a wireless network and granting or denying to the wireless device use of said one or more services based on the determination made by the AAA server.

4. The system of claim 3, wherein the wireless device derives a private access key from said at least one public access key and uses the private access key to decrypt said at least one service key to obtain at least one decrypted service key.

5. The system of claim 1, wherein the first network component is a first authentication-authorization-accounting (AAA) server associated with a first service network provider (SNP), and wherein the second network component is an access network provider (ANP) associated with the wireless network, the ANP being associated with a second AAA server that is different from the first AAA server, the first AAA server receiving at least one of said one or more key distribution requests directly or indirectly from the ANP, the second AAA server receiving at least one of said one or more key distribution requests directly or indirectly from the ANP, the first AAA server performing at least an authentication and authorization process to determine whether or not the wireless device is to be granted access to one or more services provided by the SNP, the second AAA server performing at least an authentication and authorization process to determine whether or not the wireless device is to be granted access to the wireless network, the ANP causing said at least one public access key and at least one encrypted service key to be distributed to the wireless device via said over-the-air interface if the first and second AAA servers determine, respectively, that the wireless device is to be granted access to one or more services provided by the SNP and that the wireless device is to be granted access to the wireless network.

6. The system of claim 5, wherein the key exchange process is performed using an Extensible Authentication Protocol (EAP), wherein during the key exchange process, the information communicated to the wireless device includes at least one public access key, and wherein the wireless device derives a private access key from said at least one public access key received from the second network component, the wireless device having at least one service key pre-configured in the wireless device, the wireless device using said at least one private access key to access the wireless network via the over-the-air interface and using said at least one service key to access said one or more services provided by the SNP.

7. A method for performing key distribution and key management in a wireless communications network, the method comprising:
receiving one or more key distribution requests associated with a wireless device in a first network component;
determining in the first network component whether said one or more key distribution requests are to be granted;
in a second network component, performing a key exchange process with a wireless device if the first network component determines that said one or more key distribution requests are to be granted, the second network component causing information to be communicated to the wireless device during the key exchange process via an over-the-air interface to enable the wireless device to gain access to the wireless network and one or more services associated with said one or more key distribution requests.

8. The method of claim 7, wherein the key exchange process includes:
receiving at least one master key sent from the first network component in the second network component if the first network component determines that said one or more key distribution requests are to be granted;
in the second network component, deriving at least one public access key and at least one service key from said at least one master key;
in the second network component, deriving at least one private access key from said at least one public access key; and
in the second network component, using said at least one private access key to encrypt said at least one service key to obtain at least encrypted service key, and wherein the information communicated to the wireless device via the over-the-air interface includes said at least one public access key and said at least one encrypted service key.

9. The method of claim 8, wherein the first network component is an authentication-authorization-accounting (AAA) server and the second network component is an access network provider (ANP), the AAA server receiving said one or more key distribution requests directly or indirectly from the ANP, the AAA server performing at least an authentication and authorization process to determine whether or not the wireless device is to be granted access to the wireless network and to determine whether or not the wireless device is to be granted use of one or more services, the ANP granting or denying to the wireless device access to a wireless network and granting or denying to the wireless device use of said one or more services based on the determination made by the AAA server.

10. The method of claim 9, wherein the wireless device derives a private access key from said at least one public access key and uses the private access key to decrypt said at least one service key to obtain at least one decrypted service key.

11. The method of claim 7, wherein the first network component is a first authentication-authorization-accounting (AAA) server associated with a first service network provider (SNP), and wherein the second network component is an access network provider (ANP) associated with the wireless network, the ANP being associated with a second AAA server that is different from the first AAA server, the first AAA server receiving at least one of said one or more key distribution requests directly or indirectly from the ANP, the second AAA server receiving at least one of said one or more key distribution requests directly or indirectly from the ANP, the first AAA server performing at least an authentication and authorization process to determine whether or not the wireless device is to be granted access to one or more services provided by the SNP, the second AAA server performing at least an authentication and authorization process to determine whether or not the wireless device is to be granted access to the wireless network, the ANP causing said at least one public access key and at least one encrypted service key to be distributed to the wireless device via said over-the-air interface if the first and second AAA servers determine, respectively, that the wireless device is to be granted access to one or more services provided by the SNP and that the wireless device is to be granted access to the wireless network.

12. The method of claim 11, wherein the key exchange process is performed using an Extensible Authentication Protocol (EAP), wherein during the key exchange process, the information communicated to the wireless device includes at least one public access key, and wherein the wireless device derives a private access key from said at least one public access key received from the second network component, the wireless device having at least one service key pre-configured in the wireless device, the wireless device using said at least one private access key to access the wireless network via the over-the-air interface and using said at least one service key to access said one or more services provided by the SNP.

13. A computer program for performing key distribution and key management in a wireless communications network, the program comprising instructions stored on a computer-readable medium, the instructions comprising:
instructions for receiving key information in a second network component, the key information being sent from a first network component to the second network component if the first network component determines that one or more key distribution requests are to be granted;
instructions for processing said key information in the second network component to obtain at least one public access key and at least one service key; and
instructions for performing a key exchange process to cause information to be communicated to a wireless device via an over-the-air interface to enable the wireless device to gain access to the wireless network and one or more services associated with said one or more key distribution requests.

14. The computer program of claim 13, wherein the key information includes at least one master key sent from the first network component in the second network component if the first network component determines that said one or more key distribution requests are to be granted, said instructions for processing said key information including:
instructions for deriving at least one public access key and at least one service key from said at least one master key;
in the second network component, deriving at least one private access key from said at least one public access key; and
instructions for using said at least one private access key to encrypt said at least one service key to obtain at least encrypted service key, and wherein the information communicated to the wireless device via the over-the-air interface includes said at least one public access key and said at least one encrypted service key.

15. The computer program of claim 14, wherein the first network component is an authentication-authorization-accounting (AAA) server and the second network component is an access network provider (ANP), the AAA server receiving said one or more key distribution requests directly or indirectly from the ANP, the AAA server performing at least an authentication and authorization process to determine whether or not the wireless device is to be granted access to the wireless network and to determine whether or not the wireless device is to be granted use of one or more services, the ANP granting or denying to the wireless device access to a wireless network and granting or denying to the wireless device use of said one or more services based on the determination made by the AAA server.

16. The computer program of claim 15, wherein the wireless device derives a private access key from said at least one public access key and uses the private access key to decrypt said at least one service key to obtain at least one decrypted service key.

17. The computer program of claim 13, wherein the first network component is a first authentication-authorization-accounting (AAA) server associated with a first service network provider (SNP), and wherein the second network component is an access network provider (ANP) associated with the wireless network, the ANP being associated with a second AAA server that is different from the first AAA server, the first AAA server receiving at least one of said one or more key distribution requests directly or indirectly from the ANP, the second AAA server receiving at least one of said one or more key distribution requests directly or indirectly from the ANP, the first AAA server performing at least an authentication and authorization process to determine whether or not the wireless device is to be granted access to one or more services provided by the SNP, the second AAA server performing at least an authentication and authorization process to determine whether or not the wireless device is to be granted access to the wireless network, the ANP causing said at least one public access key and at least one encrypted service key to be distributed to the wireless device via said over-the-air interface if the first and second AAA servers determine, respectively, that the wireless device is to be granted access to one or more services provided by the SNP and that the wireless device is to be granted access to the wireless network.

18. The computer program of claim 17, wherein the key exchange process is performed using an Extensible Authentication Protocol (EAP), wherein the information communicated to the wireless device includes at least one public access key, and wherein the wireless device derives a private access key from said at least one public access key received from the second network component, the wireless device having at least one service key pre-configured in the wireless device, the wireless device using said at least one private access key to access the wireless network via the over-the-air interface and using said at least one service key to access said one or more services provided by the SNP.
